(19) United States
(12) Patent Application Publication
(10) Pub. No.: US 2017/0316577 A1
(43) Pub. Date: Nov. 2, 2017

(54) APPARATUS AND METHOD FOR CHECKING WHETHER TABLE IS AT TILT

(71) Applicant: ISMEDIA CO., LTD., Anyang-si (KR)

(72) Inventors: Jong-Won KIM, Anyang-si, Gyeonggi-do (KR); Yong-Woo HAN, Seongnam-si, Gyeonggi-do (KR)

(73) Assignee: ISMEDIA CO., LTD., Anyang-si (KR)

(21) Appl. No.: 15/485,887

(22) Filed: Apr. 12, 2017

(30) Foreign Application Priority Data
Apr. 28, 2016 (KR) 10-2016-0052337

(51) Int. Cl. G06T 7/73; H04N 5/232

(52) U.S. Cl. CPC G06T 7/73; H04N 5/23296; G06T 2207/30204

(57) ABSTRACT

An apparatus and a method for checking whether a table is at tilt are provided, which are capable of checking whether a table is at tilt from an initially-set position even during an activation of an inspecting apparatus. To this purpose, a table tilt checking apparatus is provided for use in a camera module inspecting apparatus including a fixing part, a plurality of test zones provided on the fixing part, the table movable to sequentially guide a camera module to the respective test zones, and a chart provided in each of one or more test zones of the plurality of test zones, in which the table tilt checking apparatus includes a first position mark indicated on the fixing part, and a first mark photographer provided on the table, facing toward the first position mark.

### BACKGROUND

### Technical field

The present disclosure relates to an apparatus and a method for checking whether a table for use in a camera module inspecting apparatus is at tilt from an initially-set state.

### Description of the Related Art

Generally, in addition to providing the original function of a terminal, a portable terminal such as a mobile phone, a personal digital assistant (PDA), and so on is generally equipped with a camera module so as to provide a function such as photographing, video capturing, and so on, and the performance of the camera module is continuously enhanced to enable high resolution and high definition photographing.

Such camera module undergoes an operation inspection in a fabrication stage for determination of possible defect with focal point adjustment, resolution inspection, and so on.

FIG. 1 is a schematic view of a related apparatus for inspecting a camera module. For reference, FIG. 1 corresponds to FIG. 1 of KR Patent Publication No. 10-1073604, with reference numerals remained as they are, for convenience of explanation.

The related apparatus for inspecting camera module performs a process of rotating a table 31 so that a camera module is placed in a corresponding test zone, and then photographing a chart unit 50 or 60 with the camera module, receiving the photographed data and analyzing a focal state. For example, a fixed focal adjustment is performed in the first test zone using a first chart 50, and an automatic focal driving inspection in the second test zone using a second chart 60. For reference, FIG. 2 illustrates an exemplary chart unit that can be used. FIG. 2 schematically represents a related general chart, which corresponds to FIG. 16 of KR Patent Publication No. 10-0896803.

The position of the table is initially set in consideration of positional relationship with the chart that is used for inspecting the focal point, resolution, and so on of the camera module placed on the table. The current technology requires that the apparatus for inspecting camera module be stopped about once a day to check whether the table is at the initially-set position.

However, this reduces yield as the apparatus for inspecting camera module has to be stopped about once a day to check it regardless of whether the table is at the initially-set position.

### PRIOR ART DOCUMENTS

KR Patent Publication No. 10-1073604 (registered on Oct. 7, 2011)

### SUMMARY

A technical object of the present disclosure is to provide an apparatus and a method for checking whether a table is at tilt, which are capable of checking whether a table is at tilt from an initially-set position even during an activation of the inspecting apparatus.

In order to achieve the objects described above, a table tilt checking apparatus is provided for use in a camera module inspecting apparatus including a fixing part, a plurality of test zones provided on the fixing part, the table movable to sequentially guide a camera module to the respective test zones, and a chart provided in each of one or more test zones of the plurality of test zones, in which the table tilt checking apparatus includes a first position mark indicated on the fixing part, and a first mark photographer provided on the table, facing toward the first position mark.

In an initial state in which the camera module inspecting apparatus is installed in a normal state, a position of the first position mark or the first mark photographer may be determined such that the first position mark is placed at a first point of an area that is photographed by the first mark photographer.

In an example, the fixing part may include a main base placed apart downward from the table.

The first position mark may be indicated on the main base.

In another example, the fixing part may further include a first pillar member fixed to a portion of the main base.

The first position mark may be indicated on the first pillar member.

The first pillar member may be passed through a center of the table.

In another example, the first pillar member may be placed apart outward from an outer circumference of the table.

Meanwhile, according to an exemplary embodiment, a table tilt checking method using the table tilt checking apparatus according to the exemplary embodiment described above is provided, which may include, in an initial state in which the camera module inspecting apparatus is installed in a normal state, adjusting the first position mark or the first mark photographer such that the first position mark is placed at a first point of an area that is photographed by the first mark photographer, when the table is moved from the first position and returned to the first position, driving the first mark photographer to photograph the first position mark, and checking whether the first position mark is placed at the first point of the area photographed by the first mark photographer, and if the first position mark is not at the first point, determining that the table is tilted from the initial state.

Meanwhile, when the one or more test zones include first and second test zones, and the one or more charts include a first chart provided in the test zone and a second chart provided in the second test zone, the first position mark may be indicated on a portion of the fixing part that corresponds to the first test zone, and the table tilt checking apparatus according to the exemplary embodiment described above may further include a second position mark indicated on a portion of the fixing part that corresponds to the second test zone, and a first mark photographer provided on the table, facing toward the second position mark.

The fixing part may include a main base placed apart downward from the table.

In an example, the first and second position marks may be indicated on the main base.

In another example, the fixing part may further include a first pillar member fixed to a portion of the main base.

The first pillar member may be passed through a center of the table, and the first and second position marks may be indicated on the first pillar member.

In another example, the fixing part may further include a second pillar member fixed to other portion of the main base, and the first pillar member may be placed apart outward from the outer circumference of the table, while being in a position corresponding to the first test zone. The second pillar member may be placed apart outward from the outer circumference of the table, while being in a position corresponding to the second test zone, and the first and second position marks may be indicated on the first and second position marks, respectively.

Meanwhile, a table tilt checking method using the table tilt checking apparatus according to the exemplary embodiment described above is provided, which may include: in an initial state in which the camera module inspecting apparatus is installed in a normal state, adjusting the first position mark or the first mark photographer such that the first position mark is placed at a first point of an area that is photographed by the first mark photographer; in the initial state in which the camera module inspecting apparatus is installed in a normal state, adjusting the second position mark or the second mark photographer such that the second position mark is placed at a second point of an area that is photographed by the second mark photographer; when the table is moved from the first position and returned to the first position, driving the first and second mark photographers to photograph the first and second position marks, respectively; and checking whether the first position mark is placed at the first point of the area photographed by the first mark photographer, and simultaneously checking whether the second position mark is placed at the second point of the area photographed by the second mark photographer, and if the first position mark is not at the first point or if the second position mark is not at the second point, determining that the table is tilted from the initial state.

### Advantageous Effects

As described above, an apparatus for checking whether a table is at tile and a method thereof according to exemplary embodiments may provide the following effects.

According to an exemplary embodiment, a technical configuration including the first position mark and the first mark photographer is provided, which enables to check whether the initially-set table is tilted or not even during activation of the camera module inspecting apparatus. As a result, yield can be enhanced than a related art, because it is not necessary to stop the camera module inspecting apparatus about once a day to inspect the same.

Further, according to an exemplary embodiment, the camera module inspecting apparatus can provide enhanced accuracy of inspection than related technology, since it is possible to check whether the table is tilted or not every time the table is returned to the initial position, with the first position mark and the first mark photographer.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a schematic view of a related apparatus for inspecting a camera module;

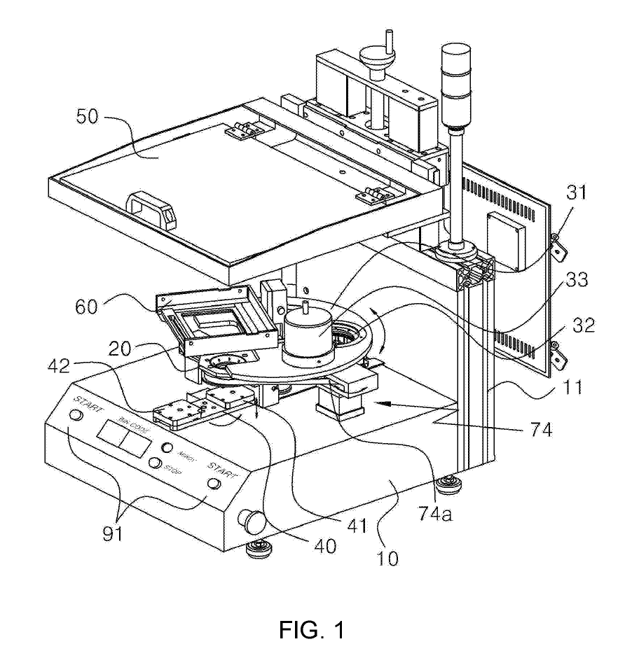

FIG. 2 is a schematic view of a related general chart;

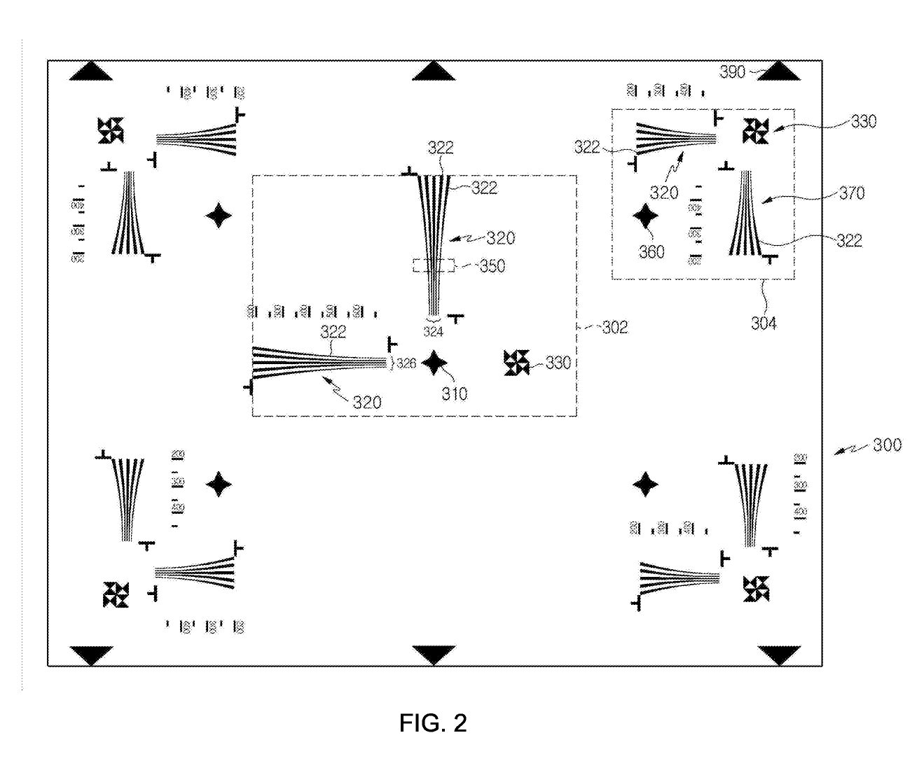

FIG. 3 is a schematic view of an apparatus for checking whether a table is at tilt according to a first exemplary embodiment;

FIG. 4 is a schematic view of an apparatus for checking whether a table is at tilt according to a second exemplary embodiment;

FIG. 5 is a schematic view of an apparatus for checking whether a table is at tilt according to a third exemplary embodiment;

FIG. 6 is a schematic view of an apparatus for checking whether a table is at tilt according to a fourth exemplary embodiment;

FIG. 7 is a schematic view of an apparatus for checking whether a table is at tilt according to a fifth exemplary embodiment; and

FIG. 8 is a schematic view of an apparatus for checking whether a table is at tilt according to a sixth exemplary embodiment.

### DETAILED DESCRIPTION

Hereinafter, preferred embodiments of the present disclosure will be described in detail with reference to the accompanying drawings. However, the description proposed herein is just a preferable example for the purpose of illustrations only, not intended to limit the scope of the disclosure, so it should be understood that other equivalents and modifications could be made thereto without departing from the scope of the disclosure.

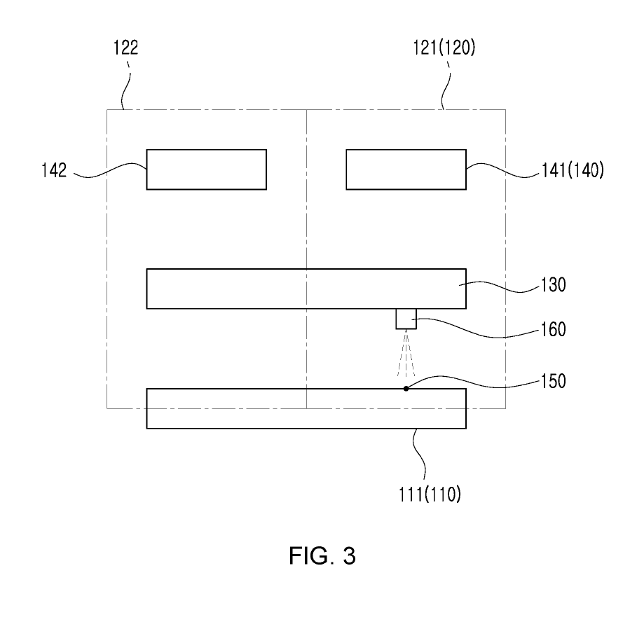

FIG. 3 is a schematic view of an apparatus for checking whether a table is at tilt according to a first exemplary embodiment.

An apparatus for checking whether a table is at tilt (hereinbelow, ‘table tilt checking apparatus’) may be adopted for use in an apparatus for inspecting camera module (hereinbelow, ‘camera module inspecting apparatus’), and may include a first position mark 150, and a first mark photographer 160, as illustrated in FIG. 3.

As illustrated in FIG. 3, the camera module inspecting apparatus may include a fixing part 110, a plurality of test zones 120 provided on the fixing part 110, a table 130 movable to sequentially guide the camera module (not illustrated) to respective test zones 120, and a chart 140 provided in each of one or more test zones of a plurality of test zones 120. Moreover, one or more test zones 120 may include first and second test zones 121, 122, and one or more charts 140 may include a first chart 141 provided in the first test zone 121, and a second chart 142 provided in the second test zone 122.

Accordingly, the camera module (not illustrated) is loaded on the table 130 via a socket (not illustrated), and upon rotation of the table 130, the camera module can be sequentially guided into respective test zones 120 for inspection thereof. For reference, although not illustrated, the technical configuration to rotate the table 130 may employ a variety of known techniques including, for example, connecting a motor to the table directly, or indirectly connecting via a pulley-belt or gear engagement for a rotation of the table. This will not be described in detail as the present disclosure does not relate to rotating a table.

As illustrated in FIG. 3, the first position mark 150 may be represented roughly in a form of a “dot” with respect to the fixing part 110. As illustrated in FIG. 3, the first mark photographer 160 may be provided on the table 130, facing toward the first position mark 150 so as to photograph around the first mark position mark 150.

Accordingly, in accordance with a first exemplary embodiment, a technical configuration including the first position mark 150 and the first mark photographer 160 is provided, which enables to check whether the initially-set table 130 is tilted or not even during activation of the camera module inspecting apparatus. As a result, yield can be enhanced than a related art, because it is not necessary to stop the camera module inspecting apparatus about once a day to inspect the same. Further, according to a first exemplary embodiment, the camera module inspecting apparatus can provide enhanced accuracy of inspection than related technology, since it is possible to check whether the table 130 is tilted or not every time the table is returned to the initial position, with the first position mark 150 and the first mark photographer 160.

Specifically, in the initial state in which the camera module inspecting apparatus is installed in a normal state, the position of the first position mark 150 or the first mark photographer 160 may be determined such that the first position mark 150 is placed at a first point of an area that is photographed by the first mark photographer 160. Accordingly, when the first position mark 150 photographed through the first mark photographer 160 indicates that the first position mark 150 is deviated from the first point, it can be determined that the table 130 is at tilt.

Further, as illustrated in FIG. 3, the fixing part 110 may include a main base 111 positioned apart downward from the table 130. In the above example, the first position mark 150 may be marked on an upper surface of the main base 111, and the first mark photographer 160 may be provided on a lower surface of the table 130.

Meanwhile, a method of checking whether a table is at tilt according to a first exemplary embodiment is a method of checking whether a table is at tilt by using the table tilt checking apparatus according to a first exemplary embodiment, and the method involves a process of adjusting the first mark photographer 160 or the first position mark 150 so that the first position mark 150 is placed at a first point of an area that is photographed by the first mark photographer 160, in an initial state in which the camera module inspecting apparatus is installed in a normal state.

When the table 130 moved from the first position is returned to the first position, the first mark photographer 160 is driven to photograph the first position mark 150.

Then, it is checked whether the first position mark 150 is placed at the first point of the area photographed by the first mark photographer 160, and if the first position mark 150 is not at the first point, it is confirmed that the table 130 is tilted from the initial state.

Further, it may be set such that, upon confirming that the table 130 is tilted, an operator may be alarmed or a camera module inspecting apparatus may be automatically stopped.

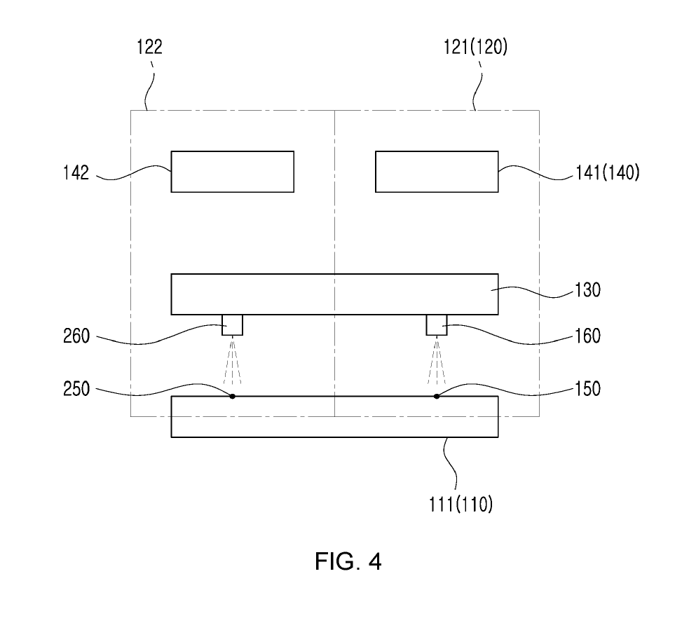

Hereinbelow, an apparatus for checking whether a table is at tilt according to a second exemplary embodiment will be described with reference to FIG. 4.

FIG. 4 is a schematic view of an apparatus for checking whether a table (hereinbelow, ‘table tilt checking apparatus’) is at tilt according to a second exemplary embodiment.

As illustrated in FIG. 4, the table tilt checking apparatus according to a second exemplary embodiment is almost identical to the first exemplary embodiment described above, except for further including a second position mark 250 and a second mark photographer 260. Accordingly, the second exemplary embodiment will be described below mainly with respect to the second position mark 250 and the second mark photographer 260.

As illustrated in FIG. 4, when the first position mark 150 is marked at a portion of the main base 111 that corresponds to the first test zone 121 provided with the first chart 141, the second position mark 250 may be marked at a portion of the main base 111 that corresponds to the second test zone 122 provided with the second chart 142. The second mark photographer 260 may be provided on the table 130, facing toward the second position mark 250 so as to photograph around the second mark position mark 250.

Accordingly, in accordance with the second exemplary embodiment, another effect can be obtained in addition to the effect of the first exemplary embodiment described above. That is, because the first position mark 150 and the first mark photographer 160 are provided in the first test zone 121 where the first chart 141 is provided, and also because the second position mark 250 and the second mark photographer 260 are provided in the second test zone 122 where the second chart 142 is provided, when the position relationship between the first chart 141 and a portion of the table 130 facing the first chart is different from the position relationship between the second chart 142 and the other portion of the table 130 facing the second chart 142, the first position mark 150 and the first mark photographer 160, and the second position mark 250 and the second mark photographer 260 may be independently checked. As a result, the camera module inspecting apparatus can provide further increased accuracy of inspection.

Meanwhile, a method of checking whether a table is at tilt according to a second exemplary embodiment is a method of checking whether a table is at tilt by using the table tilt checking apparatus according to a second exemplary embodiment, and the method involves a process of adjusting the first mark photographer 160 or the first position mark 150 so that the first position mark 150 is placed at a first point of an area that is photographed by the first mark photographer 160, in an initial state in which the camera module inspecting apparatus is installed in a normal state. After or before the above, in an initial state in which the camera module inspecting apparatus is installed in a normal state, the method involves a process of adjusting the second mark photographer 260 or the second position mark 250 so that the second position mark 250 is placed at a second point of an area that is photographed by the second mark photographer 260.

When the table 130 moved from the first position is returned to the first position, the first and second mark photographers 160, 260 are driven to photograph the first and second position marks 150, 250.

Then, it is checked whether the first position mark 150 is placed at the first point of the area photographed by the first mark photographer 160, and also checked whether the second position mark 250 is placed at the second point of the area photographed by the second mark photographer 260, and if the first position mark 150 is not at the first point or if the second position mark 250 is not at the second point, it is confirmed that the table 130 is tilted from the initial state.

Further, it may be set such that, upon confirming that the table 130 is tilted, an operator may be alarmed or a camera module inspecting apparatus may be automatically stopped.

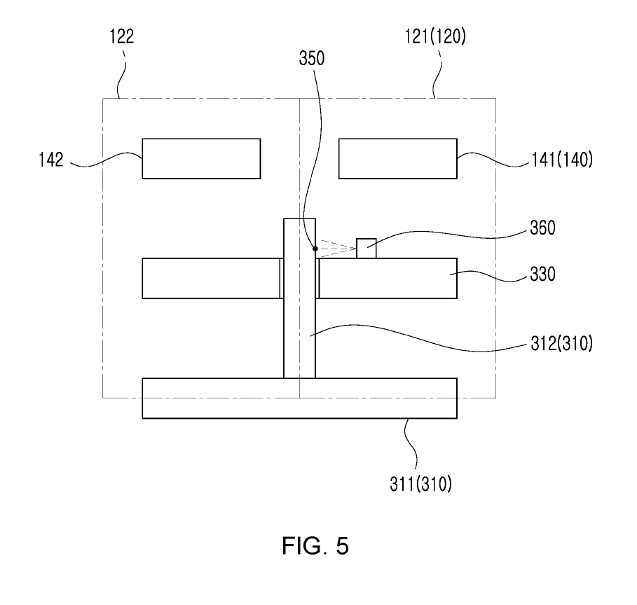

Hereinbelow, an apparatus for checking whether a table is at tilt according to a third exemplary embodiment will be described with reference to FIG. 5.

FIG. 5 is a schematic view of an apparatus for checking whether a table is at tilt according to a third exemplary embodiment.

As illustrated in FIG. 5, the table tilt checking apparatus according to a third exemplary embodiment is almost identical to the first exemplary embodiment described above, except for a configuration of the fixing part 310, a shape of the table 330, and positions at which the first position mark 350 and the first mark photographer 360 are provided. Accordingly, the third exemplary embodiment will be described below mainly with respect to the configuration of the fixing part 310, and the positions at which the first position mark 350 and the first mark photographer 360 are provided.

The fixing part 310 may further include a main base 311 placed apart downward from the table 330, and a first pillar member 312 fixed to the main base 311. Specifically, the first pillar member 312 may be placed through a center of the table 330. In the above example, the first position mark 350 may be marked on a first pillar member 312, and the first mark photographer 360 may be provided on an upper surface of the table 330. Of course, although not illustrated, when the first position mark 312 is marked on the first pillar member 312 that is between the main base 311 and the table 330, the first mark photographer 360 may be provided on a lower surface of the table 330.

Accordingly, in accordance with a third exemplary embodiment, the effect of the first exemplary embodiment described above is provided, and also it is not necessary to change the structure, i.e., to increase the position of the table 330 to use the same, even when a space between the main base 311 and the table 330 is narrow.

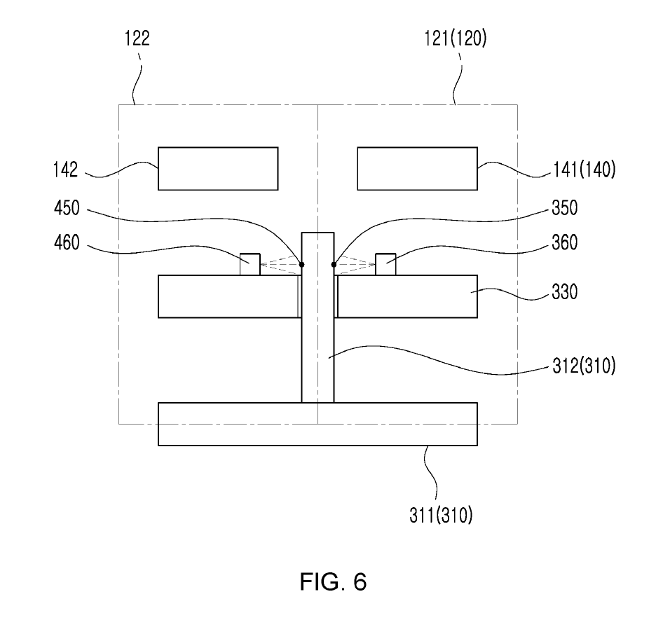

Hereinbelow, an apparatus for checking whether a table is at tilt according to a fourth exemplary embodiment will be described with reference to FIG. 6.

FIG. 6 is a schematic view of an apparatus for checking whether a table is at tilt (hereinbelow, ‘table tilt checking apparatus’) according to a fourth exemplary embodiment.

As illustrated in FIG. 6, the table tilt checking apparatus according to a fourth exemplary embodiment is almost identical to the third exemplary embodiment described above, except for further including a second position mark 450 and a second mark photographer 460. Accordingly, the fourth exemplary embodiment will be described below mainly with respect to the second position mark 450 and the second mark photographer 460.

As illustrated in FIG. 6, when the first position mark 350 is marked at a portion of the first pillar member 312 that corresponds to the first test zone 121 provided with the first chart 141, the second position mark 450 may be marked at a portion of the first pillar member 312 that corresponds to the second test zone 122 provided with the second chart 142. The second mark photographer 460 may be provided on the table 330, facing toward the second position mark 450 so as to photograph around the second mark position mark 450.

Accordingly, in accordance with the fourth exemplary embodiment, another effect can be obtained in addition to the effect of the third exemplary embodiment described above. That is, because the first position mark 350 and the first mark photographer 360 are provided in the first test zone 121 where the first chart 141 is provided, and also because the second position mark 450 and the second mark photographer 460 are provided in the second test zone 122 where the second chart 142 is provided, when the position relationship between the first chart 141 and a portion of the table 330 facing the first chart is different from the position relationship between the second chart 142 and the other portion of the table 330 facing the second chart 142, the first position mark 350 and the first mark photographer 360, and the second position mark 450 and the second mark photographer 460 may be independently checked. As a result, the camera module inspecting apparatus can provide further increased accuracy of inspection.

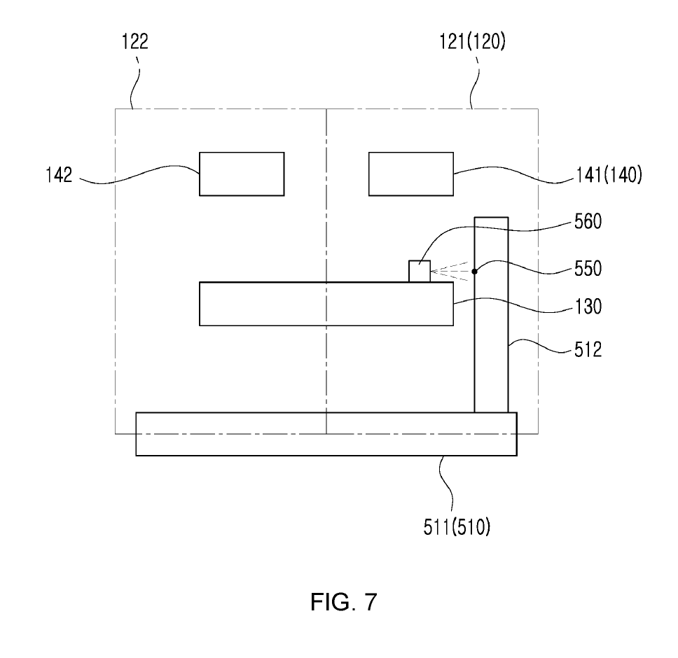

Hereinbelow, an apparatus for checking whether a table is at tilt according to a fifth exemplary embodiment will be described with reference to FIG. 7.

FIG. 7 is a schematic view of an apparatus for checking whether a table is at tilt (hereinbelow ‘table tilt checking apparatus’) according to a fifth exemplary embodiment.

As illustrated in FIG. 7, the table tilt checking apparatus according to a fifth exemplary embodiment is almost identical to the first exemplary embodiment described above, except for a configuration of the fixing part 510, and positions at which the first position mark 550 and the first mark photographer 560 are provided. Accordingly, the fifth exemplary embodiment will be described below mainly with respect to the configuration of the fixing part 510, and the positions at which the first position mark 550 and the first mark photographer 560 are provided.

The fixing part may further include a main base 511 placed apart downward from the table 130, and a first pillar member 512 fixed to the main base 511. Specifically, the first pillar member 512 may be placed apart outward from an outer circumference of the table 130. In the above example, the first position mark 550 may be marked on a first pillar member 512, and the first mark photographer 560 may be provided on an upper surface of the table 130. Of course, although not illustrated, when the first position mark is marked on the first pillar member that is between the main base and the table, the first mark photographer may be provided on a lower surface of the table.

Accordingly, in accordance with the fifth exemplary embodiment, the effect of the first exemplary embodiment described above is provided, and also it is not necessary to change the structure, i.e., to increase the position of the table 130 to use the same, even when a space between the main base 511 and the table 130 is narrow. Further, an embodiment may be applied for a type in which a motor (not illustrated) is directly connected to a center of the table 130 to rotate the table 130.

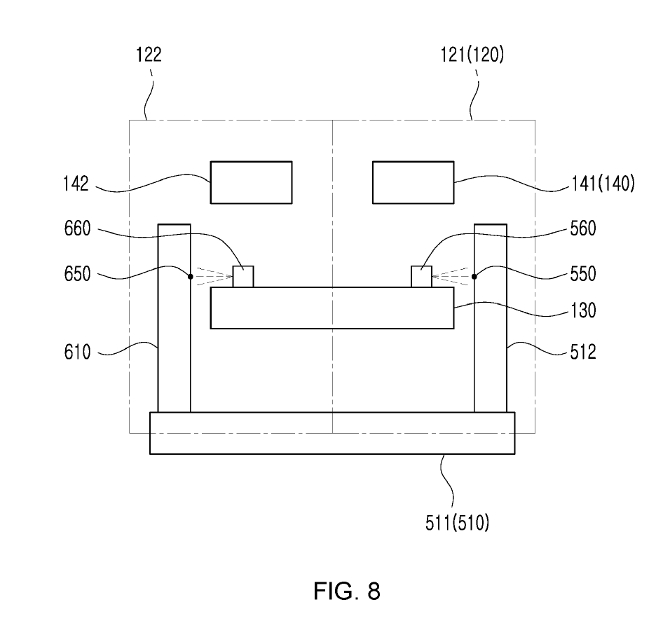

Hereinbelow, an apparatus for checking whether a table is at tilt according to a sixth exemplary embodiment will be described with reference to FIG. 8.

FIG. 8 is a schematic view of an apparatus for checking whether a table is at tilt (hereinbelow ‘table tilt checking apparatus’) according to a sixth exemplary embodiment.

As illustrated in FIG. 8, the table tilt checking apparatus according to a sixth exemplary embodiment is almost identical to the fifth exemplary embodiment described above, except for further including a first pillar member 610, a second position mark 650 and a second mark photographer 660. Accordingly, the sixth exemplary embodiment will be described below mainly with respect to the second pillar member 610, the second position mark 650, and the second mark photographer 660.

As illustrated in FIG. 8, when the first pillar member 512 is provided at a portion corresponding to the first test zone 121 that is provided with the first chart 141, the second pillar member 610 may be provided at a portion corresponding to the second test zone 122 that is provided with the second chart 142.

When the first position mark 550 is marked on the first pillar member 512, facing toward the first mark photographer 560, the second position mark 650 may be marked on the second pillar member 610, facing toward the second mark photographer 660.

The second mark photographer 660 may be provided on the table 130, facing toward the second position mark 650 so as to photograph around the second mark position mark 650.

Accordingly, in accordance with the sixth exemplary embodiment, another effect can be obtained in addition to the effect of the first exemplary embodiment described above. That is, because the first position mark 550 and the first mark photographer 560 are provided in the first test zone 121 where the first chart 141 is provided, and also because the second position mark 650 and the second mark photographer 660 are provided in the second test zone 122 where the second chart 142 is provided, when the position relationship between the first chart 141 and a portion of the table 130 facing the first chart is different from the position relationship between the second chart 142 and the other portion of the table 130 facing the second chart 142, the first position mark 550 and the first mark photographer 560, and the second position mark 650 and the second mark photographer 660 may be independently checked. As a result, the camera module inspecting apparatus can provide further increased accuracy of inspection.

As described above, an apparatus for checking whether a table is at tile and a method thereof according to exemplary embodiments may provide the following effects.

According to exemplary embodiments, a technical configuration including the first position mark 150, 350, 550 and the first mark photographer 160, 360, 560 is provided, which enables to check whether the initially-set table 130, 330 is tilted or not even during activation of the camera module inspecting apparatus. As a result, yield can be enhanced than a related art, because it is not necessary to stop the camera module inspecting apparatus about once a day to check the same.

Further, according to exemplary embodiments, the camera module inspecting apparatus can provide enhanced accuracy of inspection than related technology, since it is possible to check whether the table 130, 330 is tilted or not every time the table 130, 330 is returned to the initial position, with the first position mark 150, 350, 550 and the first mark photographer 160, 360, 560.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

What is claimed is:

1. A table tilt checking apparatus for use in a camera module inspecting apparatus comprising a fixing part, a plurality of test zones provided on the fixing part, the table movable to sequentially guide a camera module to the respective test zones, and a chart provided in each of one or more test zones of the plurality of test zones, the table tilt checking apparatus comprising:
a first position mark indicated on the fixing part; and
a first mark photographer provided on the table, facing toward the first position mark.

2. The table tilt checking apparatus of claim 1, wherein, in an initial state in which the camera module inspecting apparatus is installed in a normal state, a position of the first position mark or the first mark photographer is determined such that the first position mark is placed at a first point of an area that is photographed by the first mark photographer.

3. The table tilt checking apparatus of claim 1, wherein the fixing part comprises a main base placed apart downward from the table.

4. The table tilt checking apparatus of claim 3, wherein the first position mark is indicated on the main base.

5. The table tilt checking apparatus of claim 3, wherein the fixing part further comprises a first pillar member fixed to the main base, and the first position mark is indicated on the first pillar member.

6. The table tilt checking apparatus of claim 5, wherein the first pillar member is passed through a center of the table.

7. The table tilt checking apparatus of claim 5, wherein the first pillar member is placed apart outward from an outer circumference of the table.

8. The table tilt checking apparatus of claim 1, wherein, when the one or more test zones comprise first and second test zones, and the one or more charts comprise a first chart provided in the first test zone and a second chart provided in the second test zone,
the first position mark is indicated on a portion of the fixing part that corresponds to the first test zone, and
the table tilt checking apparatus further comprises:
a second position mark indicated on a portion of the fixing part that corresponds to the second test zone; and
a second mark photographer provided on the table, facing toward the second position mark.

9. The table tilt checking apparatus of claim 8, wherein the fixing part comprises a main base placed apart downward from the table.

10. The table tilt checking apparatus of claim 9, wherein the first and second position marks are indicated on the main base.

11. The table tilt checking apparatus of claim 9, wherein the fixing part further comprises a first pillar member fixed to a portion of the main base.

12. The table tilt checking apparatus of claim 11, wherein the first pillar member is passed through a center of the table, and the first and second position marks are indicated on the first pillar member.

13. The table tilt checking apparatus of claim 11, wherein the fixing part further comprises a second pillar member fixed to other portion of the main base,
the first pillar member is placed apart outward from the outer circumference of the table, while being in a position corresponding to the first test zone,
the second pillar member is placed apart outward from the outer circumference of the table, while being in a position corresponding to the second test zone, and
the first and second position marks are indicated on the first and second position marks, respectively.

14. A table tilt checking method using the table tilt checking apparatus of claim 1, the method comprising:
in an initial state in which the camera module inspecting apparatus is installed in a normal state, adjusting the first position mark or the first mark photographer such that the first position mark is placed at a first point of an area that is photographed by the first mark photographer;
driving the first mark photographer to photograph the first position mark, when the table is moved from the first position and returned to the first position; and
checking whether the first position mark is placed at the first point of the area photographed by the first mark photographer, and if the first position mark is not at the first point, determining that the table is tilted from the initial state.

15. A table tilt checking method using the table tilt checking apparatus of claim 2, the method comprising:
in an initial state in which the camera module inspecting apparatus is installed in a normal state, adjusting the first position mark or the first mark photographer such that the first position mark is placed at a first point of an area that is photographed by the first mark photographer;
driving the first mark photographer to photograph the first position mark, when the table is moved from the first position and returned to the first position; and
checking whether the first position mark is placed at the first point of the area photographed by the first mark photographer, and if the first position mark is not at the first point, determining that the table is tilted from the initial state.

16. A table tilt checking method using the table tilt checking apparatus of claim 3, the method comprising:
in an initial state in which the camera module inspecting apparatus is installed in a normal state, adjusting the first position mark or the first mark photographer such that the first position mark is placed at a first point of an area that is photographed by the first mark photographer;
driving the first mark photographer to photograph the first position mark, when the table is moved from the first position and returned to the first position; and
checking whether the first position mark is placed at the first point of the area photographed by the first mark photographer, and if the first position mark is not at the first point, determining that the table is tilted from the initial state.

17. A table tilt checking method using the table tilt checking apparatus of claim 4, the method comprising:
in an initial state in which the camera module inspecting apparatus is installed in a normal state, adjusting the first position mark or the first mark photographer such that the first position mark is placed at a first point of an area that is photographed by the first mark photographer;
driving the first mark photographer to photograph the first position mark, when the table is moved from the first position and returned to the first position; and
checking whether the first position mark is placed at the first point of the area photographed by the first mark photographer, and if the first position mark is not at the first point, determining that the table is tilted from the initial state.

18. A table tilt checking method using the table tilt checking apparatus of claim 8, the method comprising:
in an initial state in which the camera module inspecting apparatus is installed in a normal state, adjusting the first position mark or the first mark photographer such that the first position mark is placed at a first point of an area that is photographed by the first mark photographer;
in the initial state in which the camera module inspecting apparatus is installed in a normal state, adjusting the second position mark or the second mark photographer such that the second position mark is placed at a second point of an area that is photographed by the second mark photographer;
driving the first and second mark photographers to photograph the first and second position marks, respectively, when the table is moved from the first position and returned to the first position; and
checking whether the first position mark is placed at the first point of the area photographed by the first mark photographer, and checking whether the second position mark is placed at the second point of the area photographed by the second mark photographer, and if the first position mark is not at the first point or if the second position mark is not at the second point, determining that the table is tilted from the initial state.

19. A table tilt checking method using the table tilt checking apparatus of claim 9, the method comprising:
in an initial state in which the camera module inspecting apparatus is installed in a normal state, adjusting the first position mark or the first mark photographer such that the first position mark is placed at a first point of an area that is photographed by the first mark photographer;
in the initial state in which the camera module inspecting apparatus is installed in a normal state, adjusting the second position mark or the second mark photographer such that the second position mark is placed at a second point of an area that is photographed by the second mark photographer;
driving the first and second mark photographers to photograph the first and second position marks, respectively, when the table is moved from the first position and returned to the first position; and
checking whether the first position mark is placed at the first point of the area photographed by the first mark photographer, and checking whether the second position mark is placed at the second point of the area photographed by the second mark photographer, and if the first position mark is not at the first point or if the second position mark is not at the second point, determining that the table is tilted from the initial state.

20. A table tilt checking method using the table tilt checking apparatus of claim 10, the method comprising:
in an initial state in which the camera module inspecting apparatus is installed in a normal state, adjusting the first position mark or the first mark photographer such that the first position mark is placed at a first point of an area that is photographed by the first mark photographer;
in the initial state in which the camera module inspecting apparatus is installed in a normal state, adjusting the second position mark or the second mark photographer such that the second position mark is placed at a second point of an area that is photographed by the second mark photographer;
driving the first and second mark photographers to photograph the first and second position marks, respectively, when the table is moved from the first position and returned to the first position; and
checking whether the first position mark is placed at the first point of the area photographed by the first mark photographer, and checking whether the second position mark is placed at the second point of the area photographed by the second mark photographer, and if the first position mark is not at the first point or if the second position mark is not at the second point, determining that the table is tilted from the initial state.
